(19) United States
(12) Patent Application Publication
(10) Pub. No.: US 2019/0096130 A1
(43) Pub. Date: Mar. 28, 2019

(54) VIRTUAL MOBILE TERMINAL IMPLEMENTING SYSTEM IN MIXED REALITY AND CONTROL METHOD THEREOF

(71) Applicant: AKN KOREA INC., Seoul (KR)

(72) Inventor: Hyuk Hoon SHIM, Seongnam-si (KR)

(21) Appl. No.: 15/760,970

(22) PCT Filed: Nov. 14, 2017
(86) PCT No.: PCT/KR2017/012887

§ 371 Date: Mar. 16, 2018

(30) Foreign Application Priority Data
Sep. 26, 2017 (KR) 10-2017-0124500

(51) Int. Cl. G06T 19/00; H04W 76/10; H04M 1/725

(52) U.S. Cl. CPC G06T 19/006; H04M 1/72522; H04W 76/10

(57) ABSTRACT

The present disclosure relates to a virtual mobile terminal implementing system in mixed reality and a control method thereof. According to an exemplary embodiment of the present disclosure, a method of implementing a virtual mobile terminal used in mixed reality includes: implementing a mixed reality scene including a sensed real object and an artificially implemented virtual object; detecting a target object in the implemented mixed reality scene on the basis of an identification tag; implementing an image of the virtual mobile terminal in a region of the detected target object in the mixed reality scene; and establishing a WebRTC communication connection by transmitting a communication identifier including a unique identification (ID) for establishing the WebRTC communication connection to a call partner device in the case in which a call request through the virtual mobile terminal in the mixed reality scene is received.

### TECHNICAL FIELD

The present disclosure relates to a virtual mobile terminal implementing method and a virtual mobile terminal providing system using the same, and more particularly, to a virtual mobile terminal implementing method of implementing a virtual mobile terminal in a target object in mixed reality to allow a user of the mixed reality to use the virtual mobile terminal, and a virtual mobile terminal providing system using the same.

### BACKGROUND ART

Mixed reality is semi-virtual reality implemented by overlapping a virtual space or a virtual object in a real space.

In the mixed reality, a user of the mixed reality may not only use a real object of the real space, but may also use a virtual space or a virtual object provided in the mixed reality. The mixed reality has both of an advantage that it may interact with the real world as in augmented reality and an advantage that it provides the virtual object of the virtual reality to give an immersion sense to the user, and it has thus been expected to be applied to various fields.

Since the mixed reality may be frequently used in daily life in accordance with an increase in the application of the mixed reality, a demand for a method of conveniently using a mobile terminal in the mixed reality so that the user may make a comfortable daily life in the mixed reality has recently increased.

### DISCLOSURE

### Technical Problem

An object of the present disclosure is to implement a virtual mobile terminal capable of being conveniently used in mixed reality in which a display does not exist.

Another object of the present disclosure is to provide a target object including a region in which a virtual mobile terminal may be implemented so that the virtual mobile terminal is easily used in mixed reality.

Still another object of the present disclosure is to provide a method of performing communication with another device outside mixed reality using a virtual mobile terminal in the mixed reality.

Objects that are to be solved by the present disclosure are not limited to the abovementioned objects, and objects that are not mentioned will be clearly understood by those skilled in the art to which the present disclosure pertains from the present specification and the accompanying drawings.

### Technical Solution

According to an exemplary embodiment of the present disclosure, a method of implementing a virtual mobile terminal used in mixed reality may include: implementing a mixed reality scene including a sensed real object and an artificially implemented virtual object; detecting a target object in the implemented mixed reality scene on the basis of an identification tag; implementing an image of the virtual mobile terminal in a region of the detected target object in the mixed reality scene; and establishing a WebRTC communication connection by transmitting a communication identifier including a unique identification (ID) for establishing the WebRTC communication connection to a call partner device in the case in which a call request through the virtual mobile terminal in the mixed reality scene is received.

According to another exemplary embodiment, a virtual mobile terminal implementing apparatus may include: a sensing portion sensing a real object of a real world; an output portion outputting a mixed reality scene including the sensed real object and an artificially implemented virtual object; and a control portion detecting a target object in the mixed reality scene on the basis of an identification tag, implementing an mage of the virtual mobile terminal in a region in which the target object is detected, and establishing a WebRTC communication connection by transmitting a communication identification including a unique ID for establishing the WebRTC communication connection to a call partner device in the case in which a call request through the virtual mobile terminal in the mixed reality scene is received.

Technical solutions of the present disclosure are not limited to the abovementioned solutions, and solutions that are not mentioned will be clearly understood by those skilled in the art to which the present disclosure pertains from the present specification and the accompanying drawings.

### Advantageous Effects

According to the present disclosure, the virtual mobile terminal that may be conveniently used in the mixed reality may be provided.

According to the present disclosure, the target object including the region in which the virtual mobile terminal may be implemented so that the virtual mobile terminal is easily used in mixed reality may be provided.

According to the present disclosure, the method of performing communication with another device outside the mixed reality using the virtual mobile terminal in the mixed reality may be provided.

Effects of the present disclosure are not limited to the abovementioned effects, and effects that are not mentioned will be clearly understood by those skilled in the art to which the present disclosure pertains from the present specification and the accompanying drawings.

### DESCRIPTION OF DRAWINGS

FIG. 1 is a view illustrating mixed reality provided to a user according to an exemplary embodiment of the present disclosure.

FIG. 2 is a view illustrating a virtual mobile terminal implementing system according to an exemplary embodiment of the present disclosure.

FIG. 3 is a block diagram illustrating units implemented in the virtual mobile terminal implementing system according to an exemplary embodiment of the present disclosure.

FIG. 4 is a view illustrating a virtual mobile terminal implementing device according to an exemplary embodiment of the present disclosure.

FIGS. 5A and 5B are views illustrating an example of a target object according to an exemplary embodiment of the present disclosure.

FIG. 6 is a view illustrating a virtual mobile terminal implemented on the basis of a position of a target object detected in a mixed reality scene (MR) according to an exemplary embodiment of the present disclosure.

FIG. 7 is a view illustrating a virtual mobile terminal implemented on the basis of a position of a target object detected in a virtual reality scene (VR) according to an exemplary embodiment of the present disclosure.

FIG. 8 is a view illustrating a virtual mobile terminal implemented on the basis of a position of a target object detected in an augmented reality scene (AR) according to an exemplary embodiment of the present disclosure.

FIG. 9 is a view illustrating a virtual mobile terminal of a user that uses another mixed reality.

FIG. 10 is a view illustrating a target object that moves according to an exemplary embodiment of the present disclosure.

FIGS. 11A to 11C are views illustrating a virtual mobile terminal implemented according to an exemplary embodiment of the present disclosure.

FIG. 12 is a view illustrating an interworking process between a virtual mobile terminal and a real mobile terminal according to an exemplary embodiment of the present disclosure.

FIG. 13 is a view illustrating an interworking process between a virtual mobile terminal and a real mobile terminal according to an exemplary embodiment of the present disclosure.

FIG. 14 is a view illustrating recognition of a touch through a virtual mobile terminal according to an exemplary embodiment of the present disclosure.

FIG. 15 is a view illustrating zoom-in/zoom-out through a virtual mobile terminal according to an exemplary embodiment of the present disclosure.

FIG. 16 is a view illustrating a communication operation of a virtual mobile terminal according to an exemplary embodiment of the present disclosure.

FIG. 17 is a view illustrating a communication operation of a virtual mobile terminal that uses WebRTC according to an exemplary embodiment of the present disclosure.

FIG. 18 is a view illustrating a video call operation according to an exemplary embodiment of the present disclosure.

FIG. 19 is a view illustrating an image of which a size is adjusted in mixed reality according to an exemplary embodiment of the present disclosure.

FIG. 20 is a flow chart illustrating a control method of a virtual mobile terminal implementing system according to an exemplary embodiment of the present disclosure.

### BEST MODE

Since exemplary embodiments mentioned in the present specification are provided in order to clearly explain the spirit of the present disclosure to those skilled in the art to which the present disclosure pertains, the present disclosure is not limited to exemplary embodiments mentioned in the present specification, and the scope of the present disclosure should be construed to include modifications or variations without departing from the spirit of the present disclosure.

General terms that are currently widely used were selected as terms used in the present specification in consideration of functions in the present disclosure, but may be changed depending on the intention of those skilled in the art to which the present disclosure pertains or custom, the emergence of a new technique, and the like. Alternatively, in the case in which specific terms are defined and used as arbitrary meanings, the meanings of these terms will be separately described. Therefore, terms used in the present specification should be construed on the basis of the substantial meanings of the terms and the contents throughout the present specification rather than simple names of the terms.

The accompanying drawings in the present specification are provided in order to easily explain the present disclosure, and since shapes illustrated in the drawings may be exaggerated, if necessary, in order to facilitate the understanding of the present disclosure, the present disclosure is not limited by the drawings.

In the case in which it is decided that a detailed description for well-known constructions or functions related to the present disclosure may obscure the gist of the present disclosure, it will be omitted, if necessary.

According to an exemplary embodiment of the present disclosure, a method of implementing a virtual mobile terminal used in mixed reality may include: implementing a mixed reality scene including a sensed real object and an artificially implemented virtual object; detecting a target object in the implemented mixed reality scene on the basis of an identification tag; implementing an image of the virtual mobile terminal in a region of the detected target object in the mixed reality scene; and establishing a WebRTC communication connection by transmitting a communication identifier including a unique identification (ID) for establishing the WebRTC communication connection to a call partner device in the case in which a call request through the virtual mobile terminal in the mixed reality scene is received.

In the implementing of the image of the virtual mobile terminal, the virtual mobile terminal may include a virtual object, and the virtual object may include a WebRTC communication connection object.

In the establishing of the WebRTC communication connection, the call request may be received by sensing a touch of the virtual object implemented in the virtual mobile terminal.

The sensing of the touch of the virtual object may be performed on the basis of a sound generated due to a material of a region of the target object in which the virtual object is implemented in the case in which the virtual object of the virtual mobile terminal is touched.

The sensing of the touch of the virtual object may be performed by sensing a change in an image of a region in which the virtual object of the virtual mobile terminal is formed.

The sensing of the touch of the virtual object may be performed by sensing a velocity of an object moving toward the virtual object.

In the implementing of the image of the virtual mobile terminal, a form of a region of the target object in which the virtual mobile terminal is implemented may be sensed.

The form of the region of the target object may be sensed on the basis of a form of the identification tag of the target object in the mixed reality scene.

In the establishing of the WebRTC communication connection, the communication identifier may be generated as a predetermined link.

In the establishing of the WebRTC communication connection, a predetermined parameter for controlling the call may be added to the communication identifier.

A kind of call may be determined depending on the parameter added to the communication identifier.

In the case in which the kind of call is a video call, a call image by the video call may be implemented in the virtual mobile terminal in the implementing of the image of the virtual mobile terminal.

The method may further include, in the case in which the kind of call is the video call: transmitting media data to a media server; and obtaining the media data from the media server to implement the call image.

The method may further include obtaining data of a real mobile terminal, wherein the image of the virtual mobile terminal is implemented on the basis of the data of the real mobile terminal.

According to another exemplary embodiment, a virtual mobile terminal implementing apparatus may include: a sensing portion sensing a real object of a real world; an output portion outputting a mixed reality scene including the sensed real object and an artificially implemented virtual object; and a control portion detecting a target object in the mixed reality scene on the basis of an identification tag, implementing an image of the virtual mobile terminal in a region in which the target object is detected, and establishing a WebRTC communication connection by transmitting a communication identification including a unique ID for establishing the WebRTC communication connection to a call partner device in the case in which a call request through the virtual mobile terminal in the mixed reality scene is received.

In the following description, a scene and an image may be used together. For example, a scene of mixed reality may be a mixed reality image, and a scene of a virtual mobile terminal may be an image of the virtual mobile terminal.

Hereinafter, a virtual mobile terminal implementing method and a virtual mobile terminal implementing system using the same will be described.

1. Mixed Reality

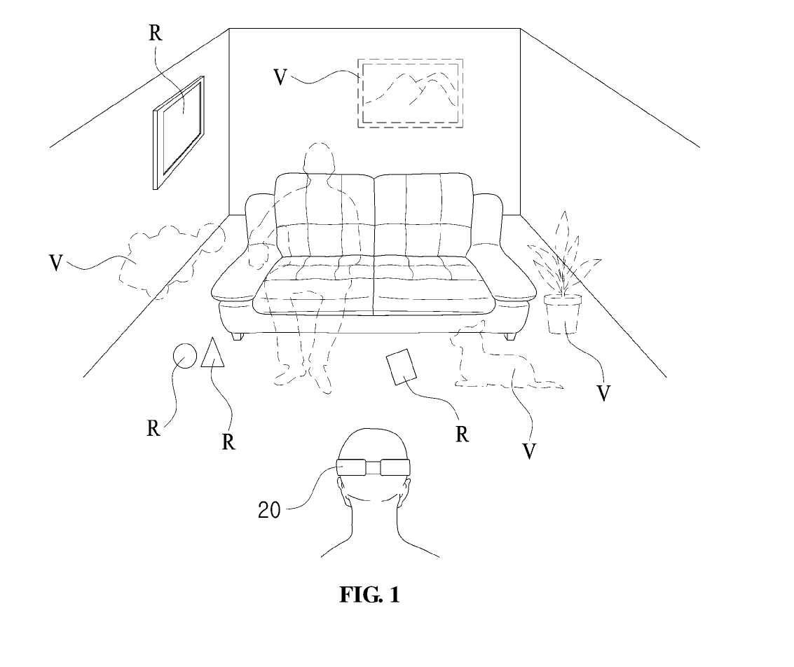

FIG. 1 is a view illustrating mixed reality provided to a user according to an exemplary embodiment of the present disclosure.

Referring to FIG. 1, the mixed reality (MR) may mean a virtual world in which reality and virtual information are mixed with each other. In other words, the mixed reality may be a virtual world implemented by overlapping virtual objects V or a virtual space on the basis of a real space. Since the mixed reality is the world implemented on the basis of the real space, a user experiencing the mixed reality may interact with the real world, and at the same time, experience the virtual space and the virtual objects V that are not reality to have a dynamic experience.

In order to provide the mixed reality, a mixed reality providing system 1 may provide an image in which the real space and the virtual space are implemented to be mixed with each other to the user. The image may be defined as a mixed reality scene. The mixed reality scene is implemented by the mixed reality providing system 1, and is provided to the user through a mixed reality implementing device 20 that the user wears, such that the user may experience the mixed reality.

The mixed reality has an advantage that it is easily used as compared with the conventional virtual reality. In the case of the existing virtual reality, a separate electronic apparatus should be provided in order to manipulate a virtual image. On the other hand, in the case of the mixed reality, the provided mixed reality scene is a world made on the basis of the real space, and thus, a change in a physical object such as a gesture, or the like, of the user may be sensed in the real space, and the mixed reality scene may be easily controlled on the basis of the sensed change in the physical object.

Meanwhile, the user of the mixed reality may communicate with other external devices using WebRTC communication in the mixed reality. Establishment of the WebRTC communication may be initiated through a predetermined communication identifier, which will be described in detail.

Meanwhile, a virtual environment used in the present disclosure may include virtual reality (VR), augmented reality (AR), and the like, in addition to the mixed reality described above. Therefore, in the following specification, the mixed reality will be described by way of example unless specifically mentioned, but the following description may also be applied to the virtual reality and the augmented reality.

1.1 Real Object and Virtual Object

Hereinafter, mixture between a real object R and a virtual object V will be described.

In a mixed reality environment, real objects R and virtual objects may exist in a state in which they are mixed with each other.

Referring to FIG. 1, in the implemented mixed reality environment, the real objects R and the virtual objects V may be simultaneously provided to a user. That is, the user may simultaneously experience the real objects R and the virtual objects V in the mixed reality environment.

The virtual objects V may be provided to the user of the mixed reality providing system implementing the mixed reality environment by the mixed reality providing system. In other words, a provider of the mixed reality environment may implement the virtual objects V provided to the user through the mixed reality providing system. That is, various virtual objects V may be implemented and controlled depending on purposes in the mixed reality environment, and may be provided to the user of the mixed reality providing system through the mixed reality providing system. In other words, the mixed reality providing system may provide virtual devices in the mixed reality environment to the user depending on a predetermined virtual device implementing method.

As described above, the user may experience the virtual objects V that do not really exist together with the real objects R of a space that really exists, such that the user may have a new experience that he/she may not have in the real world, in the mixed reality environment. In addition, the user may easily use real devices used in the real world through the virtual devices provided in the mixed reality environment. In addition, since the number and functions of virtual devices that are provided may be simply changed depending on an implementing purpose, the provider may provide a virtual device appropriate for the user to the user according to the need of the user of the mixed reality environment.

Meanwhile, in the mixed reality environment, the virtual device may be implemented and provided in a real physical object R. In other words, the provider of the mixed reality environment may provide the virtual device that the user may use in the mixed reality environment to the user through the mixed reality providing system.

The virtual device may be all the devices that may be used in the mixed reality environment, and may be, for example, a virtual mobile terminal or a predetermined input apparatus.

Hereinafter, WebRTC communication that may be used in the mixed reality will be described.

1.2 WebRTC Communication

Recently, in accordance with the development of the mobile Internet through a portable terminal apparatus such as a smartphone, many services have been developed, and Google has developed and standardized WebRTC, a real-time communication technology for implementing a web-based chat service. The WebRTC, which is a solution enabling media communication between users using only a web browser without applying an application, may be operated in all of the respective browsers supporting a standard technology regardless of a kind of operating system or terminal.

Through the technology called the WebRTC, the user may easily connect communication through the Internet, and a service publishing a user's address on the Internet and allowing other persons to access the user's address is enabled.

As a method of establishing the WebRTC communication, there may be a method of using communication identifiers such as a custom link, a web link, a quick response (QR) code, a VR link, a button, a brand logo/trademark, and the like.

Hereinafter, the respective communication identifiers will be described in detail.

The custom link may be defined as a kind of communication link generated by a user of the WebRTC communication. For example, an application called “peer” is executed through a link defined as “peer (or webpeer)://akn”, and a WebRTC communication connection may be established between a user issuing the corresponding link and a communication partner accepting the communication connection through the corresponding link.

The web link may be an http-based link. For example, when an access requester selects “http://webpeer.io/akn”, an access to an address of the corresponding link is made together with execution of a web browser, and a WebRTC communication connection may be established between a user issuing the corresponding link and a communication partner accepting the communication connection through the corresponding link.

In addition, when a connection means is provided through the QR code and an access requester recognizes the QR code through a camera of a terminal, a WebRTC communication connection may be established between a user issuing the corresponding QR code and a communication partner accepting the communication connection through the link.

The VR link receives a selection of a connection means of an access requester in the virtual environment as described above, and a WebRTC communication connection may be established between a user issuing the VR link and a communication partner accepting the communication connection through the link.

The button is displayed on a display screen so that a communication user or a communication partner may touch or click one region of a screen directly or indirectly including the link described above, such that it is possible to directly display a link address as a text or display only information of an access receiver called AKN indirectly including the link address.

In addition, in the present exemplary embodiment, it is possible that a communication user directly sets an image displayed on the button and allows his/her brand logo or trademark name to be displayed as the button.

That is, a subject using a connection setting method according to the present exemplary embodiment rather than a service subject providing the connection setting method may attach his/her brand logo or trademark name to allow the brand logo or the trademark name to be displayed on a user's terminal, thereby making it possible to allow the user can intuitively recognize what a partner that he/she is to access is by the brand logo or the trademark name.

The communication identifier may include a unique identification (ID) of a device of the user of the WebRTC communication transmitting the communication identifier. The unique ID may mean a communication address such as an Internet protocol (IP), or the like, of the device of the user for establishing the WebRTC communication or an identifiable address for establishing the communication by identifying the device of the user.

In detail, the user of the WebRTC communication may transmit the custom link, the web link, the QR code, the VR link, the button, and the brand logo/trademark described above to a device of the communication partner through a predetermined device, and the device of the communication partner may initiate the WebRTC communication with the device of the user through the unique ID included in the obtained communication identifier.

In addition, a predetermined parameter may be added to the communication identifier. The predetermined parameter is added to the communication identifier, such that the communication identifier may be implemented to perform a predetermined function simultaneously with the establishment of the communication connection. This will be described in detail. In the case in which the parameter is implemented in a uniform resource locator (URL) form, the parameter may be added in a format of “peer://ID/parameter” to the custom link, and in the case in which the parameter is implemented in a QR form, a QR may be implemented so that the corresponding function is given. A function given depending on the addition of the parameter will be described in detail in individual issues to be described below.

Hereinabove, the mixed reality providing system 1 and the WebRTC communication, which is communication that may be used in the mixed reality providing system 1, have been described.

Meanwhile, the mixed reality providing system 1 providing a virtual mobile terminal 40 of the virtual devices may be defined as a virtual mobile terminal implementing system 1.

Hereinafter, the virtual mobile terminal implementing system 1 and a virtual mobile terminal implementing method used in the virtual mobile terminal implementing system 1 will be described in detail.

2. Virtual Mobile Terminal Implementing System

FIG. 2 is a view illustrating a virtual mobile terminal implementing system 1 according to an exemplary embodiment of the present disclosure.

Referring to FIG. 2, the virtual mobile terminal implementing system 1 according to an exemplary embodiment of the present disclosure may be configured to include a target object 10, a virtual mobile terminal implementing device 20, and a server 30.

The target object 10 is a physical object providing a region in which the virtual mobile terminal 40 implemented by the virtual mobile terminal implementing system 1 may be implemented.

The virtual mobile terminal implementing device 20 may be a device implementing and providing mixed reality and a virtual mobile terminal to a user of the virtual mobile terminal implementing system 1.

The server 30 may be a service server 30. The server 30 may be provided in a cloud server form, and may store and transmit data exchanged in the virtual mobile terminal implementing system 1. Alternatively, the server 30 may be a WebRTC server 30, which is a server managing establishment of communication, exchange of data, disconnection of the communication, and the like, in connection with the WebRTC communication. In detail, in the case in which the server 30 is implemented by the WebRTC server, it may manage a communication identifier transmitted in order to establish the WebRTC communication.

Meanwhile, a virtual mobile terminal implementing system 1 including more components in addition to the components illustrated in FIG. 2 may be implemented. For example, a real mobile terminal 50 used in the real world may be further included in the virtual mobile terminal implementing system 1. In this case, the real mobile terminal 50 may interwork with the virtual mobile terminal 40 provided by the virtual mobile terminal implementing system 1, which will be described in detail below.

Hereinafter, units for providing the virtual mobile terminal 40 through the virtual mobile terminal implementing system 1 and components of the virtual mobile terminal implementing system 1 described above will be described in detail.

2.1 Virtual Mobile Terminal Implementing Unit

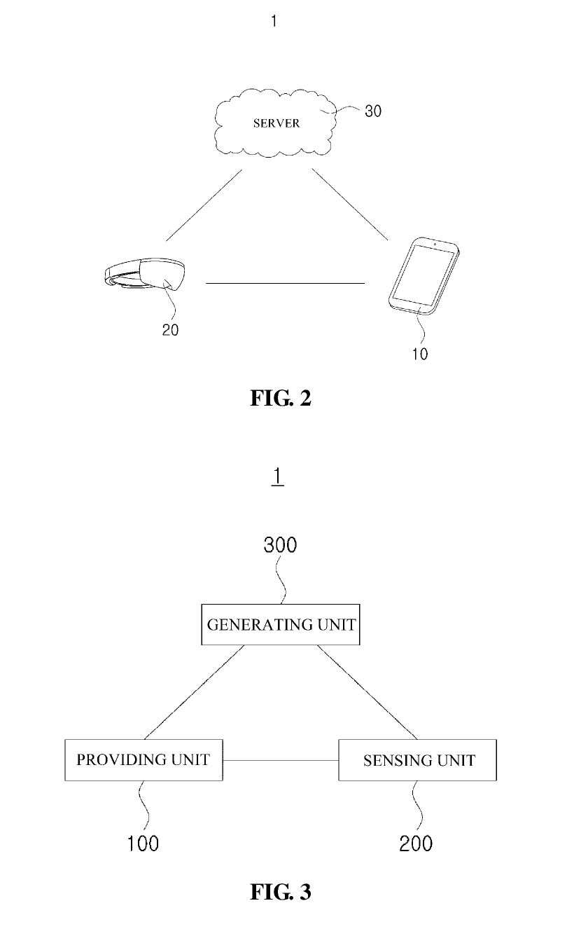

FIG. 3 is a block diagram illustrating units implemented in the virtual mobile terminal implementing system 1 according to an exemplary embodiment of the present disclosure.

In the virtual mobile terminal implementing system 1 according to an exemplary embodiment of the present disclosure, units performing operations in order to implement and control the virtual mobile terminal 40 may be implemented.

Referring to FIG. 3, the virtual mobile terminal implementing system 1 according to an exemplary embodiment of the present disclosure may include a providing unit 100, a sensing unit 200, and a generating unit 300. However, units implemented in the virtual mobile terminal implementing system 1 are not limited to those illustrated in FIG. 3, but may be more or less than those illustrated in FIG. 3.

The providing unit 100 may perform an operation of implementing and providing the virtual mobile terminal 40 that may be used in the mixed reality environment.

The sensing unit 200 may perform an operation of detecting a target object 10 providing a region for implementing the virtual mobile terminal 40 and an action of a user related to the virtual mobile terminal 40.

The generating unit 300 may obtain data related to the virtual mobile terminal 40, and generate data for implementing the virtual mobile terminal 40.

Hereinafter, the units described above will be described in detail.

The providing unit 100 may implement the virtual mobile terminal 40 in a region of the target object 10 detected by the sensing unit 200. In detail, the providing unit 100 may implement and provide the virtual mobile terminal 40 in a region of the target object 10 in the mixed reality scene. In other words, the providing unit 100 may implement an image or a scene of the virtual mobile terminal 40 in the region of the target object 10 in the mixed reality scene to provide the image or the scene to the user.

In addition, the providing unit 100 may implement the virtual mobile terminal 40 including various functions depending on an implementing purpose. For example, the providing unit 100 may implement the virtual mobile terminal 40 including a call function, a character input function, and various application functions depending on an implementing purpose of the virtual mobile terminal 40. In detail, the providing unit 100 may implement the virtual mobile terminal 40 including an object recognizing a touch, a gesture, and an audio of the user to trigger a function and may provide the virtual mobile terminal 40 to the user, in order to implement the virtual mobile terminal 40 in which the character input function is implemented. A form of the object is not limited as long as the object serves to recognize a virtual key form, an icon form, or the touch, the gesture, and the audio of the user, to trigger the function.

The sensing unit 200 may detect a path of the target object 10 so that the virtual mobile terminal 40 may be implemented in the target object 10 that moves, in the case in which the target object 10 moves.

In addition, the sensing unit 200 may detect a gesture of the user related to the virtual mobile terminal 40. For example, in the case in which the user touches the object of the virtual mobile terminal 40, the sensing unit may sense the touch of the user.

The generating unit 300 may analyze the data related to the virtual mobile terminal 40. For example, the generating unit 300 may obtain stored data from the real mobile terminal 50, and generate data for implementing the virtual mobile terminal 40 on the basis of the obtained data. The data related to the virtual mobile terminal 40 may be defined as virtual mobile data, and the data for implementing the virtual mobile terminal 40 may be defined as implementing data.

In this case, the providing unit 100 may implement the virtual mobile terminal 40 on the basis of the implementing data. In detail, in the case in which the generating unit 300 obtains application data used in the real mobile terminal 50 and generates the implementing data, the providing unit 100 may implement the virtual mobile terminal 40 including the application function on the basis of the implementing data. To this end, the generating unit 300 may provide the generated implementing data to the providing unit 100.

2.2 Component of Virtual Mobile Terminal Implementing System

Hereinafter, components of the virtual mobile terminal implementing system 1 described above will be described in detail.

2.2.1 Virtual Mobile Terminal Implementing Device

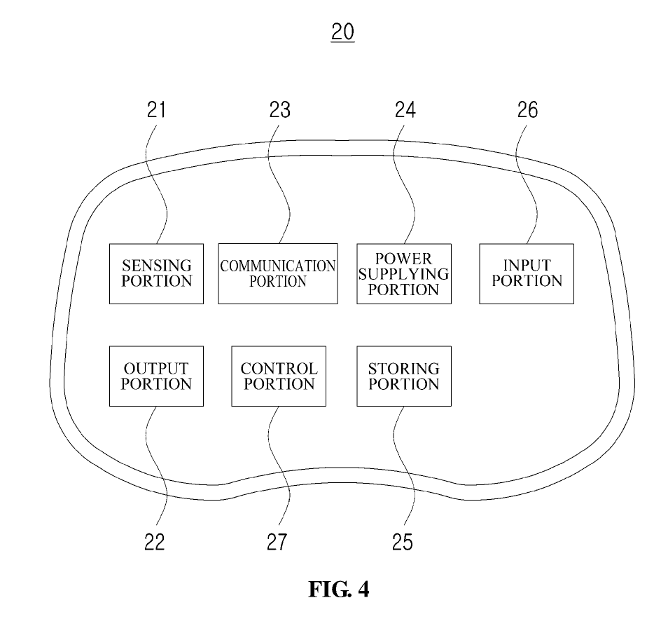

FIG. 4 is a view illustrating a virtual mobile terminal implementing device 20 according to an exemplary embodiment of the present disclosure.

The virtual mobile terminal implementing device 20 may implement and provide the mixed reality to the user, and the user may provide the virtual mobile terminal 40 so that the virtual mobile terminal 40 may be used in the mixed reality.

The virtual mobile terminal implementing device 20 as described above may be, for example, a Hololens providing the mixed reality.

The virtual mobile terminal implementing device 20 may be provided in a form in which it may be worn by the user. For example, the virtual mobile terminal implementing device 20 may be provided in a form in which it may be worn on a head of the user. Therefore, the virtual mobile terminal implementing device 20 may provide the mixed reality scene through eyes of the user to allow the user to experience the mixed reality.

In addition, the virtual mobile terminal implementing device 20 may implement and provide a virtual reality scene through the eyes of the user to allow the user to experience the virtual reality. In this case, the virtual mobile terminal implementing device 20 may be an Oculus.

In addition, the virtual mobile terminal implementing device 20 may provide an augmented reality scene to the user to allow the user to experience to the augmented reality. In this case, the virtual mobile terminal implementing device 20 may be smart devices such as a smartphone, a smart tablet, and the like, that may overlap a predetermined augmented image.

Hereinafter, unless specifically mentioned, a case in which the virtual mobile terminal implementing device 20 is a device implementing and providing the mixed reality scene will be described, in order to facilitate the description. However, the following description is not limited thereto, but may also be applied to a case in which the virtual mobile terminal implementing device 20 is a device implementing and providing the virtual reality scene VR or a device implementing and providing the augmented reality scene AR.

Referring to FIG. 4, the virtual mobile terminal implementing device 20 according to an exemplary embodiment of the present disclosure may include a sensing portion 21, an output portion 22, a communication portion 23, a power supplying portion 24, a storing portion 25, an input portion 26, and a control portion 27.

The sensing portion 21 may sense the real world. In detail, the sensing portion 21 may sense a physical object existing in the real world occupied by the user of the virtual mobile terminal implementing system 1. Therefore, in the case in which the user moves a part of his/her body, the sensing portion 21 may sense a flow line of the moving part of the user's body. In addition, the sensing portion 21 may sense a gesture of the user. In addition, the sensing portion 21 may sense a position of the target object 10.

The sensing portion 21 may be implemented by devices that may receive light reflected from physical objects of the real world to sense the real world, such as a visible light camera, an infrared camera, an image sensor, or the like.

In the case in which the sensing portion 21 is implemented by the image sensor, the sensing portion 21 may receive a visible ray emitted from a target to be image-captured by photodiodes arranged in a two-dimensional array, receive electric charges generated depending on a photoelectric effect from the photodiodes by a charge coupled device (CCD) and/or a complementary metal oxide semiconductor (CMOS), and generate data on the target.

The CCD obtains current intensity information through an amount of electrons generated in proportion to an amount of photons and generates an image using the current intensity information, and the CMOS may generate an image using voltage intensity information through an amount of electrons generated in proportion to an amount of photons. Here, the CCD may have an advantage that image quality is excellent, and the CMOS may have an advantage that a process is simple and a processing speed is fast.

In addition, as an apparatus generating the electric charges generated depending on the photoelectric effect as data, all the methods other than the CCD and/or the CMOS described above may be used depending on a use purpose.

The output portion 22 may provide the mixed reality and a virtual device that may be used in the mixed reality to the user. In detail, the output portion 22 may provide the mixed reality scene to the user to allow the user wearing the virtual mobile terminal implementing device 20 to experience the mixed reality and use the virtual mobile terminal 40.

The output portion 22 may include all of a display outputting an image, a speaker outputting a sound, a haptic apparatus generating vibrations, and various types of other output means. Hereinafter, a case in which the output portion 22 is a display that may visually transfer an image will be described. Nevertheless, in an image processing device, the image is not necessarily output to the user through the display, but may be output to the user through all of the other output means described above. The display is a concept meaning an image display apparatus in a wide sense including all of a liquid crystal display (LCD), a light emitting diode (OLED) display, an organic light emitting diode (OLED) display, a flat panel display (FPD), a transparent display, a curved display, a flexible display, a three-dimensional (3D) display, a holographic display, a projector, and various types of other apparatuses capable of performing an image output function. The display may also have a form of a touch display configured integrally with a touch sensor of the input portion 26. In addition, the output portion 22 may be implemented in a form of an output interface (a universal serial bus (USB) port, a PS/2 port, or the like) connecting an external output apparatus to the image processing device, instead of an apparatus outputting information to the outside by oneself.

The communication portion 23 may allow the virtual mobile terminal implementing device to exchange data with other external devices. The communication portion 23 may transmit and receive data in a wired or wireless manner. To this end, the server communication portion may be configured of a wired communication module accessing the Internet, or the like, through a local area network (LAN), a mobile communication module accessing a mobile communication network via a mobile communication base station to transmit and receive data, a short distance communication module using a wireless LAN (WLAN) based communication manner such as wireless fidelity (Wi-Fi) or a wireless personal area network (WPAN) based communication manner such as Bluetooth or Zigbee, a satellite communication module using a global navigation satellite system (GNSS) such as a global positioning system (GPS), or a combination thereof.

The power supplying portion 24 may provide power required for operations of the respective components of the virtual mobile terminal implementing device 20. The power supplying portion 24 may be implemented by a rechargeable battery.

In addition, according to an exemplary embodiment of the present disclosure, the virtual mobile terminal implementing device 20 may further include a power generating portion (not illustrated), which may generate power by oneself and provide the generated power to the power supplying portion. As an example, the power generating portion may include a photovoltaic power generating portion. In this case, the power generating portion may generate power through photovoltaic power generation.

The storing portion 25 may store the data. The storing portion 25 may store the data related to the mixed reality. For example, the storing portion 25 may store the virtual mobile data described above.

An operating system (OS) for driving, firmware, middleware, and various programs assisting in the operating system, the firmware, and the middleware may be stored in the storing portion 25, and data, and the like, received from other external devices such as the image processing device may be stored in the storing portion 25.

In addition, a typical example of the storing portion 25 may include a hard disk drive (HDD), a solid state drive (SSD), a flash memory, a read-only memory (ROM), a random access memory (RAM), a cloud storage, or the like.

The input portion 26 may receive a user input from the user. The user input may be performed in various forms including a key input, a touch input, and an audio input. For example, the input portion 26 may receive implementing execution of the virtual mobile terminal 40 input from the user.

In addition, a typical example of the input unit 26 includes all of a touch sensor sensing a touch of the user, a microphone receiving an audio signal, a camera recognizing a gesture of the user through image recognition, a proximity sensor configured of an illuminance sensor, an infrared sensor, or the like, sensing user approach, a motion sensor recognizing a user operation through an acceleration sensor, a gyro sensor, or the like, and various types of input means sensing or receiving various types of user inputs, in addition to a keypad, a keyboard, and a mouse having a traditional form. Here, the touch sensor may be implemented by a piezoelectric or capacitive touch sensor sensing a touch through a touch panel or a touch film attached to a display panel, an optical touch sensor sensing a touch in an optical manner, or the like.

The control portion 27 may control operations of the respective components of the virtual mobile terminal implementing device. To this end, the control portion 27 may perform calculation and processing of various data of the virtual mobile terminal implementing device 20. Therefore, the operations of the virtual mobile terminal implementing device may be performed by the control portion 27 unless specifically mentioned.

The control portion 27 may be implemented by a computer or an apparatus similar to the computer depending on hardware, software, or a combination thereof. The control portion 27 in a hardware manner may be provided in an electronic circuit form such as a central processing unit (CPU) chip, or the like, processing an electrical signal to perform a control function, and the control portion 27 in a software manner may be provided in a program form driving the control portion 27 in the hardware manner.

2.2.2 Server

The server 30 may include a server communication portion, a server database, and a server control portion.

The server communication portion may communicate with an external device (for example, the virtual mobile terminal implementing device 20). Therefore, the server may transmit and receive information to and from the external device through the server communication portion. For example, the server may exchange the data related to the mixed reality from the virtual mobile terminal implementing device 20 using the server communication portion. Since the server communication portion may transmit and receive the data in a wired or wireless manner as in the communication portion 23 of the virtual mobile terminal implementing device 20, an overlapping description for the server communication portion will be omitted.

The server database may store various information. The server database may temporarily or semi-permanently store data. For example, an operating system (OS) for operating a server, data for hosting a web site, data on a program or an application (for example, a web application) for use of a virtual mobile terminal, or the like, may be stored in the server database of the server, and data related to the virtual mobile terminal obtained from the virtual mobile terminal implementation device 20, or the like, may be stored in the server database of the server.

An example of the server database may include a hard disk drive (HDD), a solid state drive (SSD), a flash memory, a read-only memory (ROM), a random access memory (RAM), or the like. The server database may be provided in an embedded type or a detachable type.

The server control portion controls a general operation of the server. To this end, the server control portion may perform calculation and processing of various information, and control operations of components of the server. For example, the server control portion may execute a program or an application for converting a document. The server control portion may be implemented by a computer or an apparatus similar to the computer depending on hardware, software, or a combination thereof. The server control portion in a hardware manner may be provided in an electronic circuit form processing an electrical signal to perform a control function, and the server control portion in a software manner may be provided in a program form driving the server control portion in the hardware manner. Meanwhile, in the following description, it may be interpreted that the operation of the server is performed under a control of the server control portion unless specifically mentioned.

2.2.3 Target Object

Hereinafter, the target object 10 will be described.

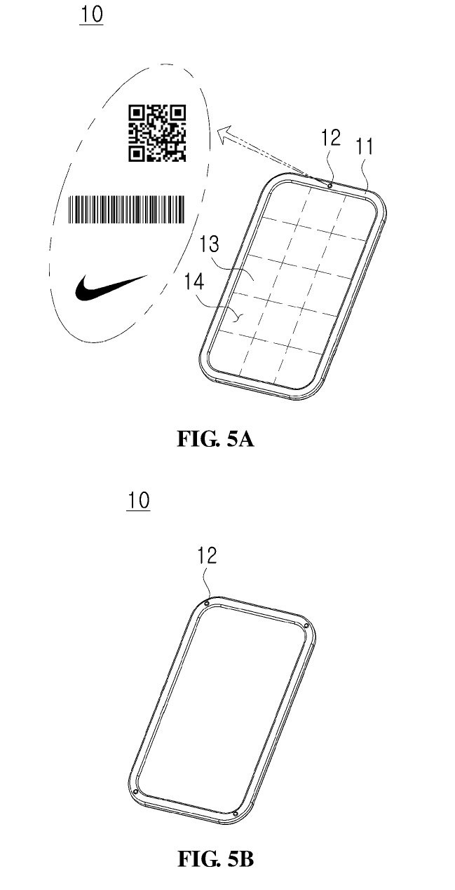

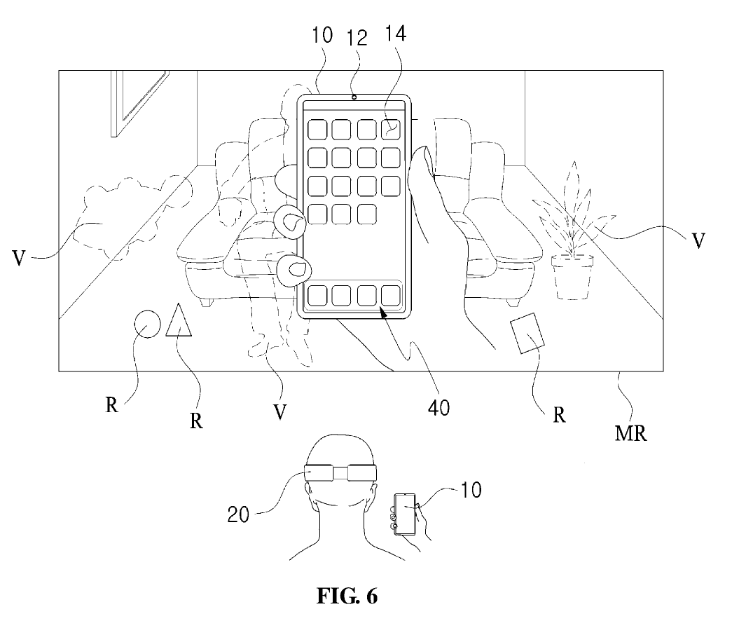

FIGS. 5A and 5B are views illustrating an example of a target object 10 according to an exemplary embodiment of the present disclosure.

The target object 10 may provide a region in which the virtual mobile terminal 40 is implemented. In other worlds, the target object 10 may be a reference on which the virtual mobile terminal 40 is implemented in the mixed reality. In a state in which the real objects R and the virtual objects V existing in the mixed reality are mixed with each other, the target object 10 may provide a region so that the virtual mobile terminal 40 may be implemented. The region in which the virtual mobile terminal 40 is provided may be defined as an implementing region 14.

The target object 10 may be a part of a user's body such as an arm, a back of a hand, a palm, or the like, or various real physical objects existing in the real world.

For example, the target object 10 may be a predetermined figure. The figure may be implemented in a form of various characters or be implemented by a character in a form desired by the user.

In addition, the target object may be a low power physical object. In this case, the low power physical object may display a basic interface such as a clock at ordinary times. Rich contents may be displayed using the mixed reality.

Hereinafter, a case in which the target object 10 is a physical object separately provided in order to implement the virtual mobile terminal 40 will be described.

As described above, in the case of implementing the virtual mobile terminal 40 through the separately provided physical object, the user may easily use the virtual mobile terminal 40. In the case in which the target object 10 is not the separately provided physical object, but one of physical objects in the real space occupied by the user, the virtual mobile terminal 40 may be implemented in one of physical objects distributed in various places. In this case, the user should search for and use the physical object in which the virtual mobile terminal 40 is implemented, and it may thus become cumbersome to use the virtual mobile terminal 40. On the other hand, in the case of implementing the virtual mobile terminal 40 through the separately provided physical object, the virtual mobile terminal 40 is implemented in the separately provided physical object, and a time required for the user to search for a position at which the virtual mobile terminal 40 is implemented may thus be reduced.

Referring to FIG. 5A, the target object 10 may be provided in a flat panel shape.

In addition, the separately provided physical object may be provided in a form in which it may be possessed by the user. Therefore, in the case in which the user desires to receive the virtual mobile terminal 40, the user may receive the virtual mobile terminal 40 by implementing the mixed reality regardless of a place.

In addition, the target object 10 is not limited to that illustrated in FIGS. 5A and 5B, but may be implemented in a form desired by the user and by a material desired by the user. For example, the target object 10 may be implemented by a flexible material to be thus bent. In addition, for example, the target object 10 may be implemented by a transparent material.

The target object 10 may be implemented by a frame 11 and a flat panel surface 13.

The frame 11 may include an identification tag 12. In detail, the identification tag 12 may be formed on an outer surface of the frame 11.

The identification tag 12 may allow the target object 10 to be identified in the mixed reality. In detail, in the case in which the target object 10 exists in the mixed reality, the sensing unit 200 described above may sense the identification tag 12 to sense a position of the target object 10. Therefore, the providing unit 100 may implement the virtual mobile terminal 40 in the implementing region 14 of the target object 10.

For example, the identification tag 12 may be a mean authenticating the user. For example, the virtual mobile terminal 40 corresponding to the identification tag 12 is provided, such that the virtual mobile terminal 40 may be provided to an authenticated user. Alternatively, information on a form and a size of the target object 10 is included in the identification tag 12, such that the virtual mobile terminal 40 may be implemented only in the case in which the information of the target object 10 obtained from the identification tag 12 and the target object 10 coincide with each other.

The identification tag 12 may be a QR code, various polygons, a barcode, or the like, and a tag may be provided in a non-restrictive form as long as it may perform a function of the identification tag 12 described above. For example, the identification tag 12 may be a form itself such as a shape, a size, or the like, of the target object 10. The target object 10 may be detected in the mixed reality scene on the basis of the form of the target object 10.

In addition, the identification tag 12 may allow a virtual mobile terminal of a user that uses another mixed reality to be recognized. In detail, in the case in which an identification tag of a target object of another user is detected in the mixed reality scene of the user when another user implements and uses a virtual mobile terminal using a target object including a predetermined identification tag, the virtual mobile terminal of another user may be represented in the mixed reality scene of the user.

Meanwhile, in the case in which the target object 10 is a part of the user's body, a specific part of the user's body may also be the identification tag 12. For example, in the case in which the palm of the user is the target object 10, a fingerprint or lines of the palm of the user may be the identification tag 12. In detail, in the case in which the virtual mobile terminal is implemented on the palm, the user may be authenticated using the fingerprint or the lines of the palm as the identification tag, and the virtual mobile terminal for the corresponding user may be implemented.

Referring to FIG. 5B, the identification tag described above is not limited to being formed at the position as illustrated in FIG. 5A, but may also be formed at a corner. Therefore, a position in which the virtual mobile terminal should be implemented in the target object may be easily detected through the identification tag formed at the corner.

The flat panel surface 13 may include the implementing region 14. The implementing region 14 may include a plurality of implementing regions 14. In this case, the target object 10 may be implemented by different materials in each implementing region 14.

2.3 Type in which Virtual Mobile Terminal Implementing System is Implemented

Hereinafter, a type in which the virtual mobile terminal implementing system 1 is implemented will be described.

The virtual mobile terminal implementing system 1 may be implemented in a stand alone type or a network type.

The stand alone type may be defined as a type in which all of the units described above are implemented in one component of the virtual mobile terminal implementing system 1.

The network type may be defined as a type in which the units described above are distributed and implemented in the respective components of the virtual mobile terminal implementing system 1.

Hereinafter, the respective types will be described in detail.

2.3.1 Stand Alone Type

The virtual mobile terminal implementing system 1 according to an exemplary embodiment of the present disclosure may be implemented in the stand alone type.

In this case, the providing unit 110, the sensing unit 200, and the generating unit 300 may be implemented in one component of the virtual mobile terminal implementing system 1. That is, the providing unit 110, the sensing unit 200, and the generating unit 300 may be implemented in at least one of the server 30, the virtual mobile terminal implementing device 20, and the target object 10 of the virtual mobile terminal implementing system 1.

In the case in which the respective units described above are implemented in the server 30, functions of the respective units may be performed in an application form in the virtual mobile terminal implementing device 20. For example, the user wearing the virtual mobile terminal implementing device 20 may perform an application in the virtual mobile terminal implementing device 20 in order to use the functions of the units. Therefore, the virtual mobile terminal implementing device 20 may perform communication with the server 30 through the communication portion 23, and the virtual mobile terminal implementing device 20 and the server 30 may exchange data related to implementation of the virtual mobile terminal 40 with each other. The virtual mobile terminal implementing device 20 may obtain virtual mobile data, and operate the respective components of the virtual mobile terminal implementing device 20 on the basis of the virtual mobile data to allow the virtual mobile terminal 40 to be provided to the user.

In the case in which the respective units are implemented in the virtual mobile terminal implementing device 20, the functions of the respective units may be performed in the virtual mobile terminal implementing device 20. In this case, the respective units may be implemented in the control portion 27 of the virtual mobile terminal implementing device 20. Therefore, the functions of the respective units are performed in the control portion 27, such that the target object 10 may be sensed from an image obtained through the sensing portion 21, and the implemented virtual mobile terminal 40 may be provided to the user through the output portion 22.

Hereinafter, a case in which the virtual mobile terminal implementing system 1 is implemented in the network type will be described.

2.3.2 Network Type

The virtual mobile terminal implementing system 1 according to an exemplary embodiment of the present disclosure may be implemented in the network type.

In this case, the respective units may be distributed and implemented in the respective components of the virtual mobile terminal implementing system 1. For example, the providing unit 100 and the generating unit 300 may be implemented in the server 30, and the sensing unit may be implemented in the virtual mobile terminal implementing device 20. Alternatively, the generating unit 300 may be implemented in the server 30, and the providing unit 100 and the sensing unit may be implemented in the virtual mobile terminal implementing device 20.

In addition, in another exemplary embodiment, the providing unit 100 and the generating unit 300 may be implemented in the server 30 and the virtual mobile terminal implementing device 20. In this case, operations of the providing unit 100 and the generating unit 300 implemented in the server 30 and operations of the providing unit 100 and the generating unit 300 implemented in the virtual mobile terminal implementing device 20 may be different from each other. For example, the providing unit 100 operated in the server 30 may generate an image or a scene of the virtual mobile terminal, and the providing unit 100 operated in the virtual mobile terminal implementing device 20 may generate an object.

In the case in which the virtual mobile terminal implementing system 1 is implemented in the network type, the functions of the respective units may be distributed and performed, and virtual mobile data generated depending on operations of the respective units may be exchanged. As a result, the virtual mobile terminal implementing device 20 may integrate the virtual mobile data to implement the mixed reality, implement the virtual mobile terminal 40 that may be used in the mixed reality, and provide the virtual mobile terminal 40 to the user.

Hereinafter, in order to facilitate the description, the stand alone type in which the respective units are implemented in the virtual mobile terminal implementing device 20 will be described unless specifically mentioned.

3. Use of Virtual Mobile Terminal

Hereinafter, an operation of implementing the virtual mobile terminal 40 and an operation of using the implemented virtual mobile terminal 40 will be described in detail.

The operation of implementing the virtual mobile terminal 40 may be defined as a virtual mobile terminal implementing operation.

The virtual mobile terminal 40 may be used as follows depending on the operation of using the virtual mobile terminal 40.

The user may perform a key input as if he/she uses the real mobile terminal 50 through the implemented virtual mobile terminal 40. In addition, the user may make a call through the virtual mobile terminal. In addition, the user may use various applications as if he/she uses the real mobile terminal 50 through the implemented virtual mobile terminal. In addition, in the case of making a call through the virtual mobile terminal, the WebRTC communication is used. To this end, the communication identifier may be used. This will be described in detail.

Hereinafter, the virtual mobile terminal implementing operation will be firstly described.

3.1 Virtual Mobile Terminal Implementing Operation

The virtual mobile terminal implementing operation of the virtual mobile terminal implementing system 1 according to an exemplary embodiment of the present disclosure will be described.

In order to implement the virtual mobile terminal 40, the virtual mobile terminal implementing device 20 may detect the target object 10, and generate the virtual mobile terminal 40 that is to be implemented in the target object 10.

Hereinafter, an operation of detecting the target object 10 will be first described.

3.1.1 Detection of Target Object

The virtual mobile terminal implementing device 20 according to an exemplary embodiment of the present disclosure may detect a position of the target object 10 for implementing the virtual mobile terminal 40. That is, the sensing unit 200 may detect a position at which the target object 10 exists in the mixed reality scene.

FIG. 6 is a view illustrating a virtual mobile terminal implemented on the basis of a position of a target object 10 detected in a mixed reality scene (MR) according to an exemplary embodiment of the present disclosure.

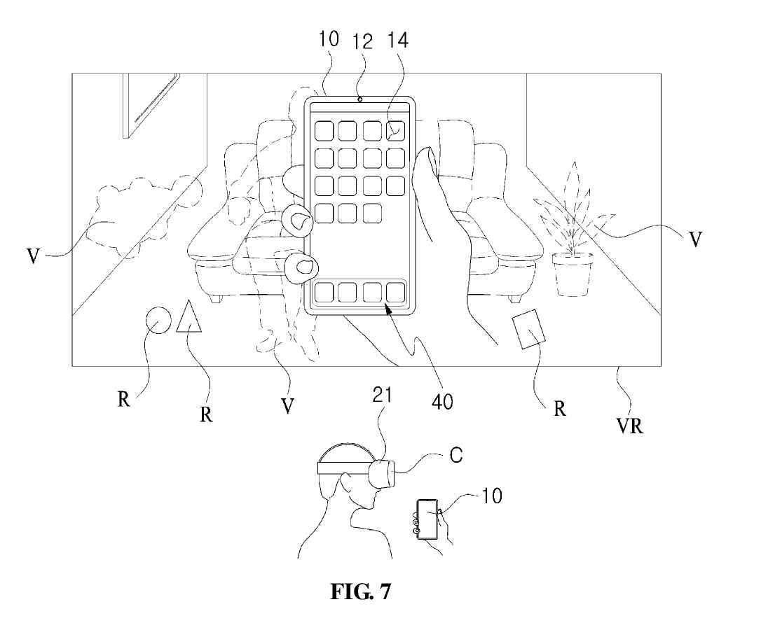

FIG. 7 is a view illustrating a virtual mobile terminal implemented on the basis of a position of a target object 10 detected in a virtual reality scene (VR) according to an exemplary embodiment of the present disclosure.

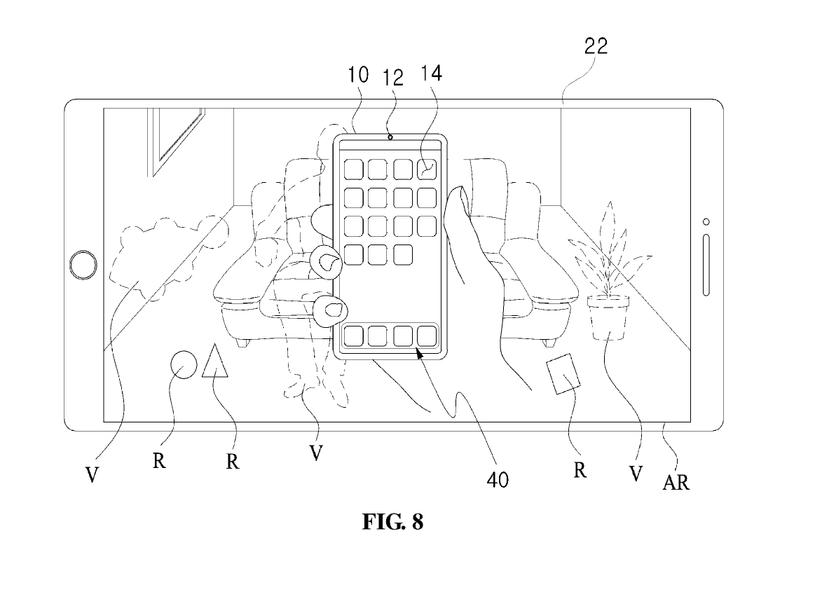

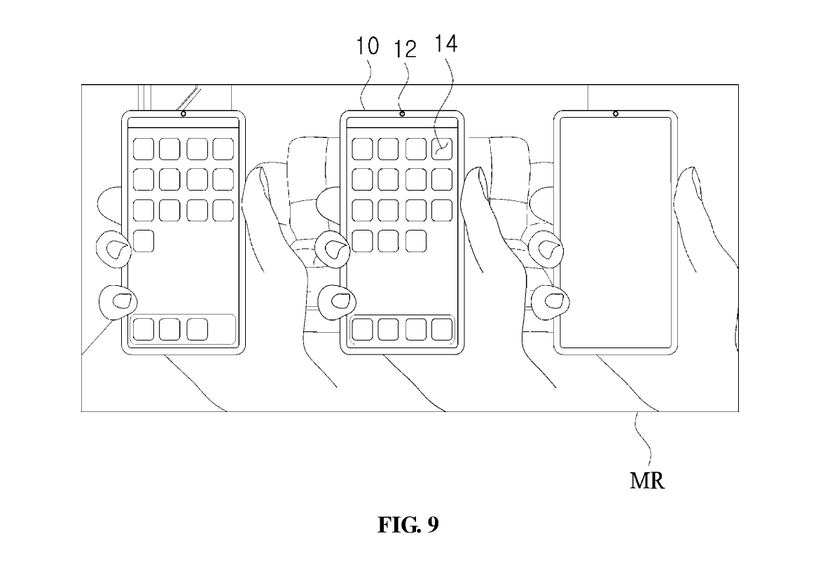

FIG. 8 is a view illustrating a virtual mobile terminal implemented on the basis of a position of a target object 10 detected in an augmented reality scene (AR) according to an exemplary embodiment of the present disclosure.

Referring to FIGS. 6 to 8, the virtual mobile terminal implementing devices 20, 21, and 22 may detect the identification tag 12 of the target object 10 to detect the position of the target object 10.

Hereinafter, a process of detecting the position of the target object 10 on the basis of the identification tag 12 will be described in detail.

Referring to FIG. 6, the position of the target object 10 may be detected by analyzing the mixed reality scene.

The analysis of the mixed reality scene may include detection of the real objects R and the virtual objects V and detection of the target object 10 of the real objects R.

The detection of the real objects R and the virtual objects V will be first described.

The sensing unit 200 may detect and classify the real objects R and the virtual objects V of the mixed reality scene.

In detail, the sensing unit may separate the real objects R, the virtual objects V, and a background from one another to detect the real objects R and the virtual objects V. To this end, conventional technologies of separating and detecting meaningful targets from a background, such as region of interest (ROI) detection, edge detection, or the like, may be used, but the present disclosure is not limited thereto, and a technology of detecting the real objects R and the virtual objects V may be used.

Meanwhile, in the case of the virtual objects V existing in the mixed reality, the virtual objects V are implemented in the mixed reality and positions of the virtual objects are grasped, and the virtual objects V may be thus detected on the basis of the grasped positions.

Meanwhile, since the target object 10 of the real objects R and the virtual objects V is the real objects R, an operation of detecting the virtual objects V may also be omitted.

Hereinafter, the detection of the target object 10 of the real objects R will be described.

The sensing unit 200 may classify the target object 10 of all the detected real objects R on the basis of the identification tag 12. In detail, the sensing unit 200 may detect the identification tag 12 from an image of all the detected real objects R to detect the target object 10.

In addition, the sensing unit 200 may detect the implementing region 14 of the detected target object 10. That is, the sensing unit 200 may detect a position, a size, a form, or the like, of the implementing region 14 of the detected target object 10 and allow the detected size and form to correspond to those of the implementing region 14 in which the implemented virtual mobile terminal 14 is positioned.

In detail, the sensing unit 200 may calculate a size of the identification tag 12 and compare the calculated size with a pre-stored size of the identification tag 12 to calculate a predetermined ratio. Therefore, the sensing unit 200 may reflect the calculated ratio in a pre-stored size of the implementing region 14 to calculate a size of the implementing region 14 of the target object 10 detected at a current point in time.

In addition, the sensing unit 200 may analyze a form of the identification tag 12 to derive a form of the implementing region 14 of the target object 10 that is currently detected. For example, in the case in which the identification tag 12 has a form in which it is inclined by a predetermined angle in an X-axis direction in a three-dimensional space, the sensing unit 200 may derive that the implementing region 14 correspondingly has a form in which it is inclined by a predetermined angle.

Meanwhile, the sensing unit 200 may continuously detect the implementing region 14 of the target object 10 in an image changed depending on movement of the target object 10.

In addition, referring to FIGS. 7 and 8, the virtual mobile terminal may be implemented by a virtual mobile terminal implementing device providing the virtual reality and a virtual mobile terminal implementing device providing the augmented reality.

Referring to FIG. 7, the virtual mobile terminal implementing device 21 may provide the virtual mobile terminal to the user of the virtual mobile terminal implementing device in the virtual reality VR. To this end, a photographing portion C photographing the front of the user may be further included in the virtual mobile terminal implementing device. Therefore, the virtual mobile terminal implementing device may detect physical objects existing in front of the virtual mobile terminal implementing device, and detect the target object including the identification tag among the physical objects. The virtual mobile terminal implementing device may implement the virtual mobile terminal in a region of the detected target object to provide the virtual mobile terminal as in a device providing the mixed reality described above.

Referring to FIG. 8, the virtual mobile terminal may also be implemented through the virtual mobile terminal implementing device 22 providing the augmented reality AR. The virtual mobile terminal implementing device may be, for example, a table personal computer (PC). In this case, the tablet PC may photograph the front of the user through a photographing portion mounted therein, and detect the target object including the identification tag from the photographed image. The tablet PC may implement the virtual mobile terminal in a region of the detected target object to provide the virtual mobile terminal to the user.

Meanwhile, as described above, the identification tag 12 may allow the virtual mobile terminal of the user that uses another mixed reality to be recognized.

FIG. 9 is a view illustrating a virtual mobile terminal of a user that uses another mixed reality.

Referring to FIG. 9, the virtual mobile terminal used by another user may be implemented or may not be implemented in the mixed reality of the user on the basis of the detected identification tag of another user. In the case in which the identification tag of the target object of another user is detected in the mixed reality scene of the user when another user implements and uses the virtual mobile terminal using the target object including the predetermined identification tag, the virtual mobile terminal of another user may be represented in the mixed reality scene of the user. That is, in the case in which the identification tag is not detected, the virtual mobile terminal of another user may not be represented in the mixed reality scene of the user. In addition, even though the identification tag of another user is detected, in the case in which the identification tag allows the virtual mobile terminal of another user not to be displayed, the virtual mobile terminal of another user may not be represented in the mixed reality scene of the user.

Meanwhile, the abovementioned description is not limited to the mixed reality, but may also be applied to the virtual reality and the augmented reality.

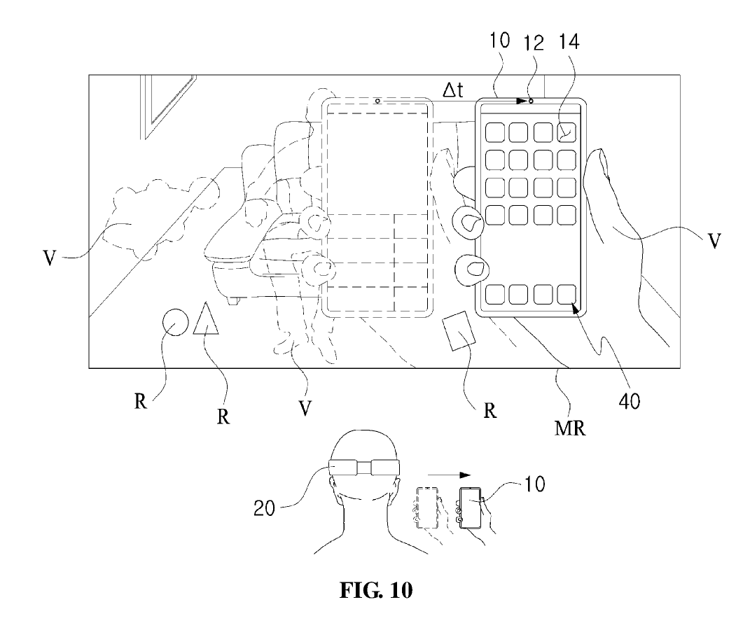

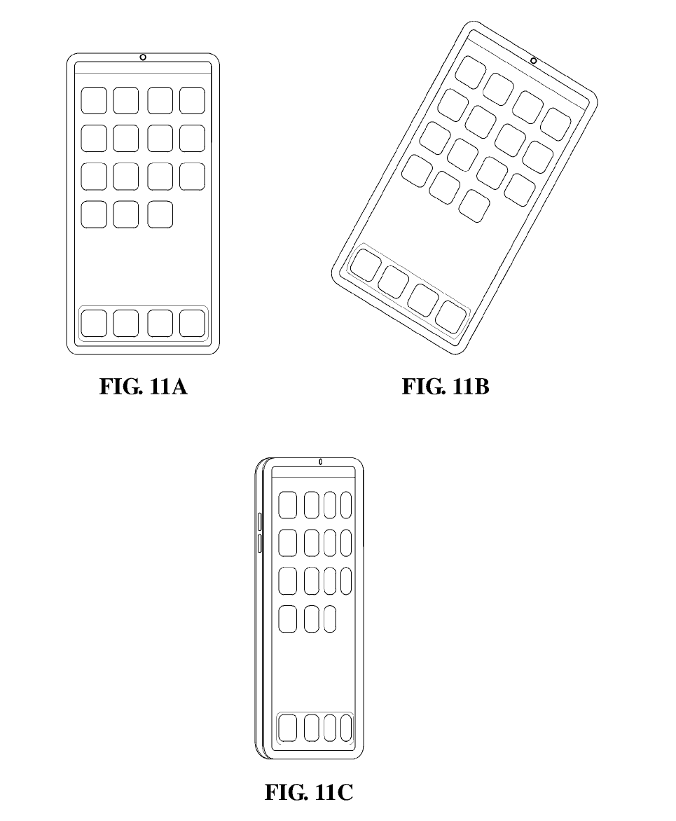

FIG. 10 is a view illustrating a target object 10 that moves according to an exemplary embodiment of the present disclosure.

Referring to FIG. 10, the mixed reality scene may be analyzed in real time to detect a position, a size, and a form of the target object 10 that is changed, on the identification tag 12.

Here, data on the target object 10 detected depending on the operation of detecting the target object 10 and the implementing region 14 of the target object 10 may be defined as detection data.

3.1.2 Implementation of Virtual Mobile Terminal

Hereinafter, implementation of the virtual mobile terminal 40 will be described.

FIGS. 11A to 11C are views illustrating a virtual mobile terminal implemented according to an exemplary embodiment of the present disclosure.

The virtual mobile terminal implementing system 1 according to an exemplary embodiment of the present disclosure may implement the virtual mobile terminal 40 in the detected target object 10. That is, the providing unit 100 may implement the virtual mobile terminal 40 in the implementing region 14 of the detected target object 10. In detail, the providing unit 100 may overlap a virtual mobile terminal image in the implementing region 14 of the mixed reality scene.

The virtual mobile terminal image may be implemented by a user interface that is the same as or similar to the real mobile terminal 50. Therefore, a description for an UI of the virtual mobile terminal 40 will be omitted.

In addition, as illustrated in FIGS. 11A to 11C, the virtual mobile terminal may be vividly implemented on the basis of the position of the target object. A rotation angle, an inclined level, and the like, of the target object may be detected, and the virtual mobile terminal having a form corresponding to the detected rotation angle, inclined level, and the like, may be implemented in the region of the target object. Therefore, the user may experience vividly using the virtual mobile terminal.

Hereinafter, interworking between the virtual mobile terminal 40 and the real mobile terminal 50 will be described in detail.

Meanwhile, the virtual mobile terminal 40 may interwork with the real mobile terminal 50.

The interworking may specifically mean that functions of the real mobile terminal 50 and the virtual mobile terminal 40 are substantially the same as each other. In other words, the use of the virtual mobile terminal 40 in the mixed reality may mean that it is substantially the same as the use of the real mobile terminal 50 in the real world.

For the purpose of the interworking, the virtual mobile terminal 40 may be implemented on the basis of data of the real mobile terminal 50.

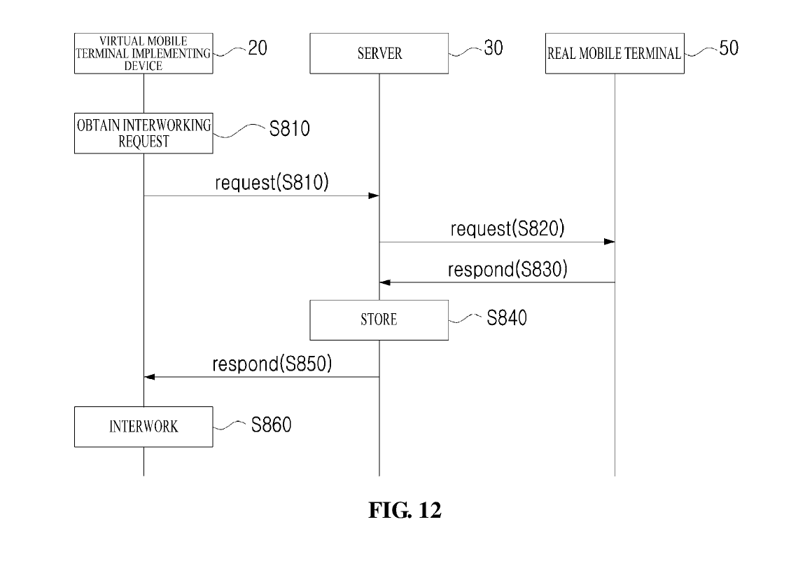

FIG. 12 is a view illustrating an interworking process between a virtual mobile terminal 40 and a real mobile terminal 50 according to an exemplary embodiment of the present disclosure.

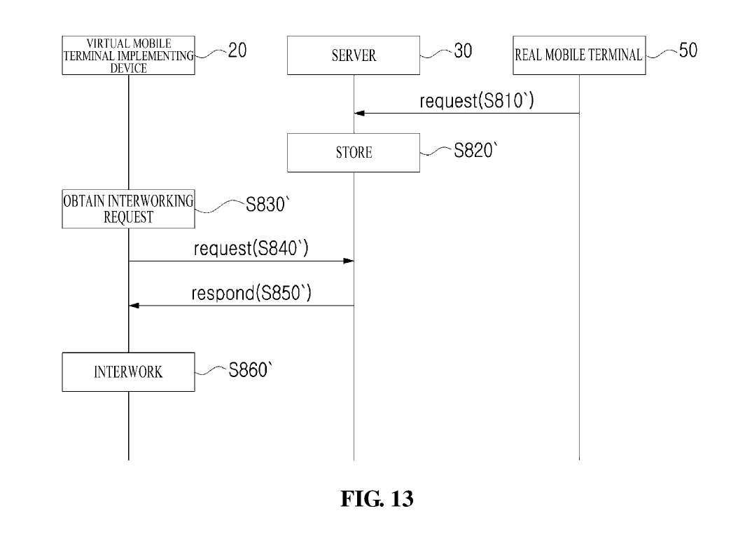

FIG. 13 is a view illustrating an interworking process between a virtual mobile terminal 40 and a real mobile terminal 50 according to an exemplary embodiment of the present disclosure.

Referring to FIGS. 12 and 13, the server 30 may be a medium of data exchange of the real mobile terminal 50 for the purpose of the interworking between the virtual mobile terminal 40 and the real mobile terminal 50. In other words, the virtual mobile terminal implementing device 20 may obtain the data of the real mobile terminal 50 through the server 30.

Referring to FIG. 12, when a request for interworking with the real mobile terminal by the user is obtained by the virtual mobile terminal implementing device 20 (S800), the virtual mobile terminal implementing device 20 may transmit the request to the server 30 (S810). The server 30 receiving the request may transmit a request for requesting the data of the real mobile terminal to the real mobile terminal (S820). In the case in which the real mobile terminal receiving the request responds to the request, the data of the real mobile terminal may be transmitted to the server 30 (S830). The server 30 obtaining the data of the real mobile terminal may store the data (S840) or transmit the data to the virtual mobile terminal implementing device 20 without storing the data (S850) to allow the virtual mobile terminal 40 to be implemented on the basis of the data of the real mobile terminal, thereby interworking the real mobile terminal 50 and the virtual mobile terminal 40 with each other (S860).

Referring to FIG. 13, the real mobile terminal 50 may store the data of the real mobile terminal before the request of the virtual mobile terminal implementing device 20. Therefore, the virtual mobile terminal implementing device 20 may obtain the stored data of the real mobile terminal 50 from the server 40, and implement the virtual mobile terminal 40 on the basis of the obtained data.

Meanwhile, the virtual mobile terminal implementing device 20 and the real mobile terminal 50 may directly perform communication therebetween to obtain the data of the real mobile terminal 50. In this case, the communication manner may be the WebRTC communication. For example, a link “PEER://ID of Real Mobile Terminal 50” may be transmitted to the virtual mobile terminal implementing device 20 through the real mobile terminal 50. Therefore, the user may initiate the WebRTC communication with the real mobile terminal 50 through the link to receive the data on the real mobile terminal 50 from the real mobile terminal 50.

Hereinabove, the implementation of the virtual mobile terminal 40 has been described. Hereinafter, the use of the virtual mobile terminal 40 will be described.

3.2 Operation of Using Virtual Mobile Terminal

Hereinafter, a method and an operation of using the virtual mobile terminal in the mixed reality will be described.

3.2.1 Recognizing Operation

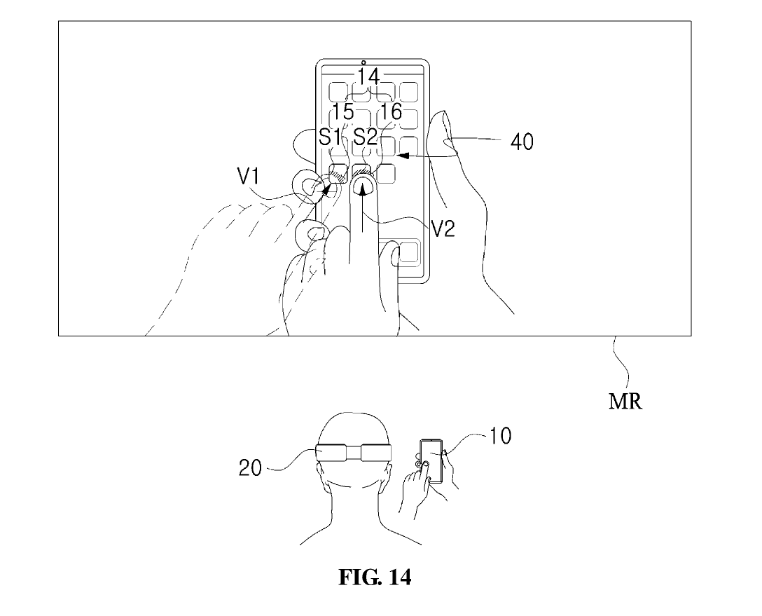

FIG. 14 is a view illustrating recognition of a touch through a virtual mobile terminal 40 according to an exemplary embodiment of the present disclosure.

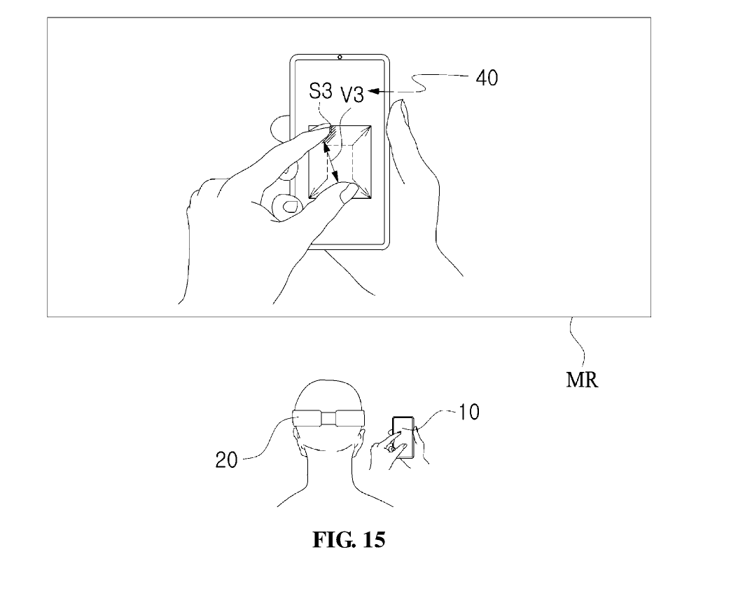

FIG. 15 is a view illustrating zoom-in/zoom-out through a virtual mobile terminal 40 according to an exemplary embodiment of the present disclosure.

Referring to FIG. 14, the virtual mobile terminal implementing system may recognize the touch of the user for the virtual mobile terminal, recognize the gesture of the user for the virtual mobile terminal, or recognize the audio of the user for the virtual mobile terminal.

The recognition of the touch of the user will be first described.

The virtual mobile terminal implementing system may recognize a physical object approaching the implemented virtual mobile terminal. In detail, the virtual mobile terminal implementing system may recognize one end of the physical object approaching the implemented virtual mobile terminal to recognize whether or not one end of the physical object touches the virtual mobile terminal.

One end of the physical object may be an end portion of the user's body, an end portion of a bar, or the like, gripped by the user, or the like.

Predetermined virtual icons as illustrated may be implemented in a region of the virtual mobile terminal in which the touch is recognized, but the present disclosure is not limited thereto, and objects triggering functions, such as predetermined virtual keys, and the like, may be implemented, and the functions may be resultantly triggered by the recognized touch. The functions may include character input (hereinafter, referred to as input), call use, image output, and the like.

In addition, the virtual mobile terminal implementing system may sense a change in a sound, an image, or the like, by one end of the physical object to recognize the touch. In detail, the virtual mobile terminal implementing system may sense a sound generated when one end of the physical object is in contact with the target object in which the virtual mobile terminal is implemented or a shadow to recognize the touch.

Hereinafter, the recognition of the gesture of the user will be described.

The virtual mobile terminal implementing system may recognize the gesture of the user for the implemented virtual mobile terminal. The guest should be interpreted as a concept including a specific operation of an object gripped by the user as well as a gesture that uses the user's body.

Therefore, predetermined functions may be triggered. The functions may include the character input (hereinafter, referred to as the input), the call use, the image output, and the like, as described above.

Hereinafter, the recognition of the audio of the user will be described.

The virtual mobile terminal implementing system may recognize the audio of the user for the implemented virtual mobile terminal.

In this case, the virtual mobile terminal implementing system may analyze the audio of the user to grasp a content. Therefore, predetermined functions may be triggered. The functions may include the character input (hereinafter, referred to as the input), the call use, the image output, and the like, as described above.

In addition, the virtual mobile terminal implementing system may recognize whether or not the audio is an audio of the user that uses the virtual mobile terminal through a procedure of authenticating the audio of the user.

Hereinafter, the recognition of the touch among the recognition methods of the virtual mobile terminal implementing system described above will be described in detail.

As described above, the predetermined function may be triggered by the recognition of the touch. The user may touch a first region 15 of the virtual mobile terminal 40 with his/her finger and touch a second region 16 of the virtual mobile terminal 40 with his/her finger, in the mixed reality. In this case, the virtual mobile terminal system may recognize the touch of the finger. As described above, for example, the recognition of the touch may be performed by the sound. Here, in the case in which the user touches the first region 15, a first sound S1 may be output due to a material of the target object 10 of the first region 15, and in the case in which the user touches the second region 16, a second sound S2 may be output due to a material of the target object 10 of the second region 16. The sensing unit 200 may sense the first sound S1 and the second sound S2, and an analyzing unit may identify the first sound S1 and the second sound S2. In the case in which the first sound S1 and the second sound S2 are identified, they may be recognized as the touch of the first region 15 and the touch of the second region 16, respectively.

In addition, as described above, the recognition of the touch may be identified on the basis of a velocity of a fingertip of the user toward the virtual mobile terminal. For example, the virtual mobile terminal implementing system may recognize the fingertip of the user to detect the velocity of the fingertip of the user. The fingertip of the user moves at a velocity that is gradually decreased, resulting in being stopped, and the virtual mobile terminal implementing system may recognize that the touch is made in a region in which the fingertip of the user is stopped. That is, a velocity V1 of the finger toward the first region 15 and a velocity V2 of the finger toward the second region 16 may be detected to recognize the respective touches.

In addition, the recognition of the touch may be detected through a change in an image. In detail, the recognition of the touch may be sensed by sensing a change in an image of a fingertip part in the mixed reality scene. For example, the recognition of the touch may be sensed on the basis of a shadow of the finger of the user. Alternatively, the recognition of the touch may be sensed by detecting a region of an image hidden by the finger of the user.

Hereinafter, performance of a zoom-in/zoom-out function by the object input will be described.

Referring to FIG. 15, the zoom-in/zoom-out function may be performed by the touch of the object of the virtual mobile terminal 40. In this case, at least two fingers of the user may be in contact with the object. Since a sound S3 and a velocity V3 are generated as at least two fingers of the user simultaneously move, the zoom-in/zoom-out is decided on the basis of the methods described above.

Meanwhile, the providing unit 100 may reflect a state of the virtual mobile terminal 40 changed depending on an interaction through the object of the user described above in the mixed reality scene to provide the mixed reality scene in which the changed state of the virtual mobile terminal 40 is reflected to the user.

Hereinafter, a call operation that uses the virtual mobile terminal 40 in the mixed reality will be described.

3.2.2 Call Operation

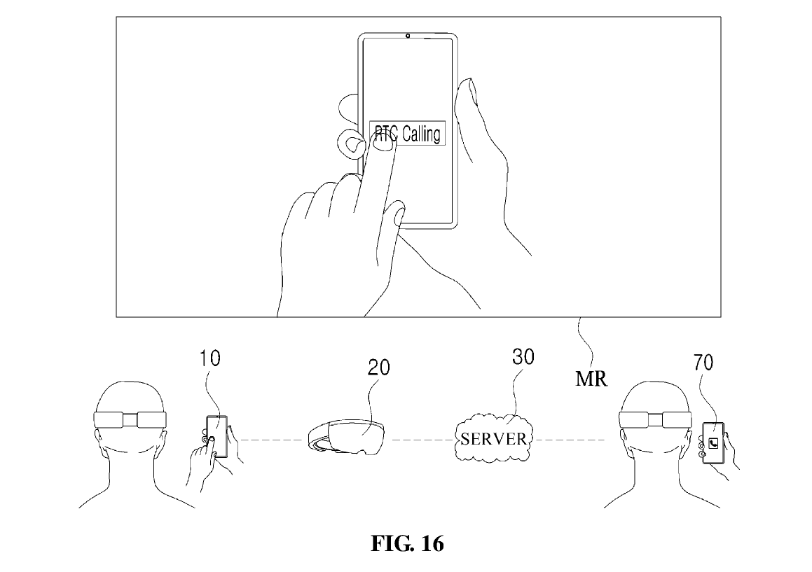

FIG. 16 is a view illustrating a communication operation of a virtual mobile terminal 40 according to an exemplary embodiment of the present disclosure.

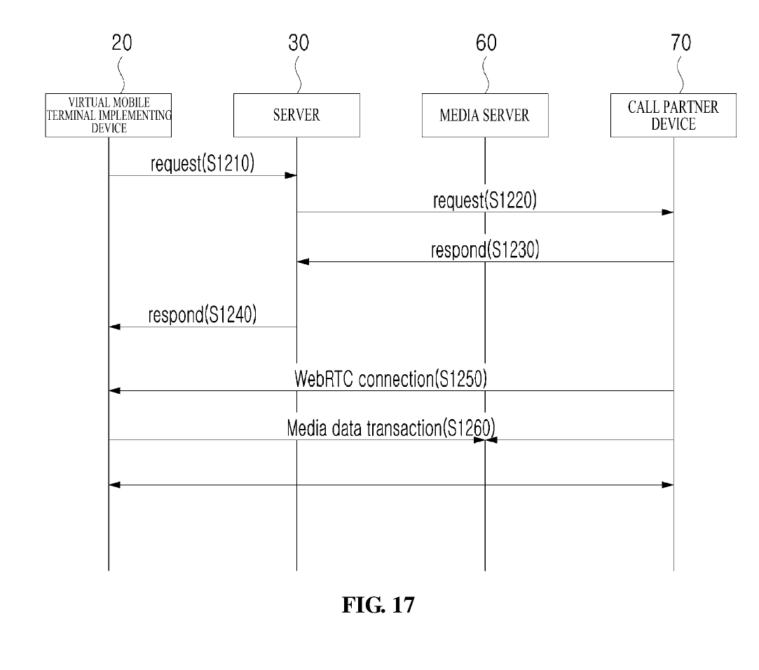

FIG. 17 is a view illustrating a communication operation of a virtual mobile terminal 40 that uses WebRTC according to an exemplary embodiment of the present disclosure.

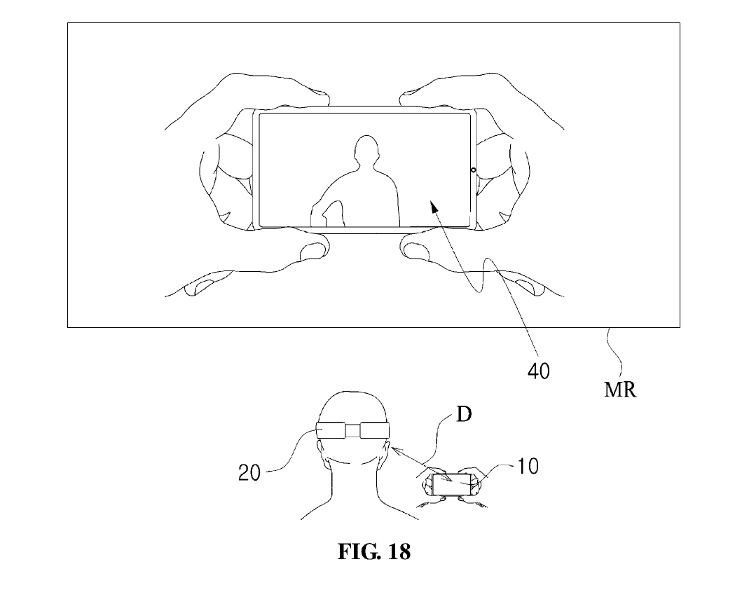

FIG. 18 is a view illustrating a video call operation according to an exemplary embodiment of the present disclosure.

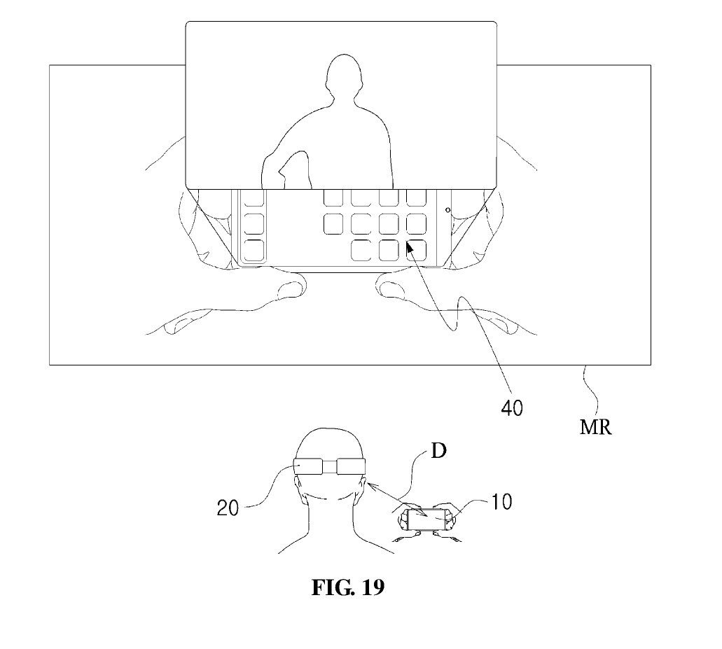

FIG. 19 is a view illustrating an image of which a size is adjusted in mixed reality according to an exemplary embodiment of the present disclosure.

Referring to FIG. 16, the user of the mixed reality according to an exemplary embodiment of the present disclosure may make a call through the virtual mobile terminal 40. A partner of the call is a person different from the user of the mixed reality, and a call device of the partner of the call may be the real mobile terminal 50, a mixed reality device, a call device based on the Internet such as WebRTC, voice over Internet protocol (VoIP), or the like. The call device of the partner of the call may be defined as a call partner device 70.

Hereinafter, a sequence of the call operation that uses the virtual mobile terminal 40 in the mixed reality will be described.

The call operation that uses the virtual mobile terminal 40 may include a call input step, a server request step, and a call connection step.

In the call input step, the user may initiate the call operation using a call function implemented in the virtual mobile terminal 40 in the mixed reality. For example, the user may touch an object triggering the call function implemented in the virtual mobile terminal 40, and the touch is sensed, such that the call operation may be initiated.

In the case in which the call is a WebRTC-based call, a communication identifier for initiating the WebRTC communication may be generated depending on the trigger of the function of the call object. A unique ID of the virtual mobile terminal implementing device 20 may be included in the communication identifier. In the case in which the communication identifier is implemented in a form of the custom link, it may be directly generated by the user, and in the case in which the communication identifier is implemented in a form of the web link, it may be generated in a preset manner. Alternatively, the communication identifier may be implemented in a form of the QR code, VR link, or the like, as described above.

As described above, in the case in which the call is made between the virtual mobile terminal implementing device 20 and the call partner device 70 on the basis of the WebRTC communication, the call may be conveniently made without causing a compatibility issue. In the case in which a separate application is installed in the virtual mobile terminal implementing device 20 to make a call, compatibility between the application and the virtual mobile terminal implementing device 20 should be considered. However, in the case in which the call is made on the basis of the WebRTC communication as described above, the call may be made using the WebRTC communication through an access of the virtual mobile terminal implementing device 20 to a web browser without installing the separate application, such that the compatibility issue may be solved. Therefore, the call may be easy.

In addition, in the case in which the call is the WebRTC-based call, the predetermined parameter may be added to the communication identifier, as described above. The call based on the WebRTC communication may be controlled depending on the added parameter. For example, a kind of call, a characteristic of the call, a method of the call, and the like, may be controlled depending on the parameter.

In the server request step, the virtual mobile terminal implementing device 20 may receive a call input of the user. In detail, the user may designate a call partner to which he/she desires to make a call, and request a call to the designated call partner through a call input. Therefore, the virtual mobile terminal implementing device 20 may request a predetermined server 30 managing a call connection to make a call to the call partner device 70.

Meanwhile, the server 30 may be a base station managing the call in the case in which the call connection is a call to the real mobile terminal 50, but as described above, the server 30 according to the present disclosure may be the server 30 managing the WebRTC communication to establish the WebRTC-based call. Therefore, the server 30 may transmit the communication identifier to the call partner device 70 of the call partner.

In the call connection step, the server 30 may receive the call request, and transmit a call connection request to the call partner device 70. Therefore, in the case in which the call partner accepts the call connection through the call partner device 70, a call connection between the virtual mobile terminal 40 and the call partner device may be made.

For example, the call partner may initiate the WebRTC communication with the virtual mobile terminal implementing device 20 of the user through the communication identifier transmitted to the call partner device 70. Therefore, the virtual mobile terminal implementing device may implement a call interface in the virtual mobile terminal 40 so that the user may make a call in the mixed reality, thereby providing an experience like substantially making a call through the virtual mobile terminal 40 to the user.

Hereinafter, a video call operation based on the WebRTC communication will be described in detail.

In order to make a video call, image data should be exchanged unlike an audio call in which only audio data are exchanged. Since the image data are data having a size larger than that of the audio data, a media server 60 may be further included in order to process the image data. The media server 60 may store the media data, and allow the respective callers to exchange the media data with each other.

Referring to FIG. 17, the virtual mobile terminal 40, the server 30, the media server 60, and the call partner device 70 may exchange data with one another in order to initiate the video call based on the WebRTC communication according to an exemplary embodiment of the present disclosure.

The virtual mobile terminal implementing device 20 may request the server 30 to transmit the communication identifier (S1210).

The server 30 may receive the communication identifier and transmit the received communication identifier to the call partner device 70 (S1220).

In the case in which the call partner accepts the call through the communication identifier transmitted to the call partner device 70, the call partner device 70 may transmit a call acceptance response to the server 30 (S1230), and transmit a call acceptance response to the virtual mobile terminal implementing device 20 (S1240), such that the WebRTC communication may be established between the virtual mobile terminal implementing device 20 and the call partner device 70 (S1250).

In the case in which the WebRTC communication is established, the media server 60 may allow the virtual mobile terminal implementing device 20 and the call partner device 70 to exchange the media data with each other (S1260). To this end, the media server 60 may receive the media data from each of the virtual mobile terminal implementing device 20 and the call partner device 70, and transmit the received media data.

In addition, the media server 60 may store the transmitted and received media data. Therefore, the user or the call partner may access the media data stored in the media server 60 to use the past media data.

Meanwhile, the video call may include a multiparty video call as well as a one-to-one video call. In the case in which the video call is the multiparty video call, the communication identifier may be transmitted to a plurality of call partner devices 70. Therefore, the virtual mobile terminal implementing device 20 and the plurality of call partner devices 70 may establish the WebRTC communication therebetween. Therefore, the media server 60 may receive the media data from each of the virtual mobile terminal implementing device 20 and the plurality of call partner devices 70, and transmit the received media data to the respective devices.

In the case of the multiparty video call, a predetermined parameter may be added to the communication identifier in order to establish the WebRTC communication with the plurality of call partner devices 70. The parameter may be a parameter that may allow a video call to all the call partner devices 70 to be established using one communication identifier. For example, the parameter may be a parameter including unique IDs of all the call partner devices 70.

In detail, the WebRTC communication with the plurality of call partner devices 70 may be established in a form of “peer://userID1/userID2/userID3”. Alternatively, in the case in which the plurality of call partner devices are managed in a list form, the WebRTC communication with the plurality of call partner devices 70 may be established in a form of “peer://userIDlist”.

Meanwhile, in order to determine a kind of call that is to be initiated, a predetermined parameter may be added to the communication identifier. For example, in the case in which the identifier is the custom link, a kind of call may be selected through the custom link to which a parameter such as “peer://userID/(call kind)” is added.

Alternatively, a base of the call is designated as an audio call, and a kind of call to the call partner may be determined using the custom link having a form such as “peer://userID/videocall”.

The user may adjust a size of the provided image depending on a gesture during the video call made using the virtual mobile terminal 40.

Referring to FIG. 18, the size of the image may be adjusted during the video call using the virtual mobile terminal 40 on the basis of the gesture of the user according to an exemplary embodiment of the present disclosure.

As described above, the gesture may be the zoom-in/zoom-out using the two fingers of the user.

Alternatively, as illustrated in FIG. 18, the size of the image may be adjusted on the basis of a distance D between the target object 10 in which the virtual mobile terminal 40 is implemented and the user. For example, in the case in which the user moves the target object 10 to decrease the distance D between the target object 10 and the user, the size of the image output by the virtual mobile terminal 40 implemented in the target object 10 may be decreased.

In addition, as illustrated in FIG. 19, the image may be extended into a mixed reality scene space. The size of the image used for the video call may be initially implemented to be a size corresponding to the implementing region of the target object 10, but the size of the image may be extended to the vicinity of the implementing region depending on a taste of the user, such that the virtual mobile terminal implementing device may allow the user to use an image implemented in a region other than the target object.

In addition, an additional content or a controller may be continuously used in the virtual mobile terminal simultaneously with the extension of the image.

4. Control Method of Virtual Mobile Terminal Implementing System

Hereinafter, a control method of a virtual mobile terminal implementing system 1 will be described.

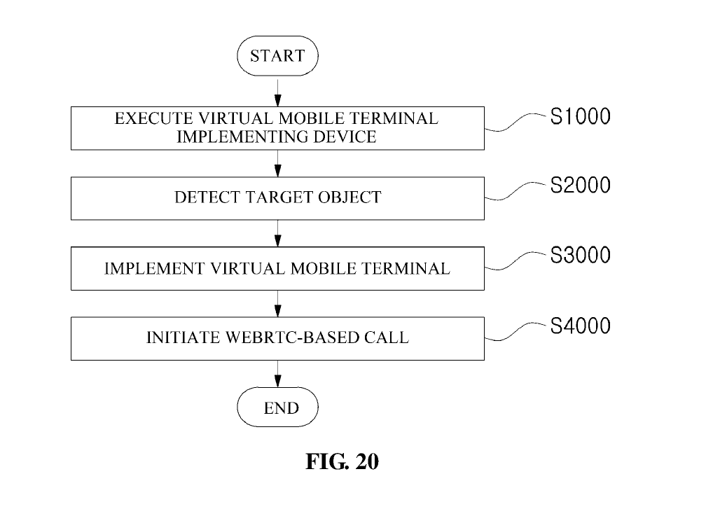

FIG. 20 is a flow chart illustrating a control method of a virtual mobile terminal implementing system 1 according to an exemplary embodiment of the present disclosure.

Referring to FIG. 20, the control method of a virtual mobile terminal implementing system 1 according to an exemplary embodiment of the present disclosure may include a mixed reality implementing step (S1000), a target object detecting step (S2000), a virtual mobile terminal implementing step (S300), and a WebRTC-based call initiating step (S4000). All the steps S1000 to S4000 may be performed. However, all the steps S1000 to S4000 should not be always performed, and only one of the steps S1000 to S4000 may be performed.

In the mixed reality implementing step (S1000), the mixed reality may be provided to the user wearing the virtual mobile terminal implementing device 20 through the virtual mobile terminal implementing device 20. The virtual mobile terminal implementing device 20 may implement the mixed reality scene, and allow the user wearing the virtual mobile terminal implementing device to view to the mixed reality scene to provide the mixed reality to the user.

In the target object detecting step (S2000), the target object 10 may be detected on the basis of the identification tag 12 in the mixed reality scene provided through the virtual mobile terminal 40. In this case, the implementing region 14 formed in the target object 10 may be detected on the basis of a form of the identification tag 12.

In the virtual mobile terminal implementing step (S3000), the virtual mobile terminal 40 may be implemented in the implementing region 14 of the detected target object 10. The virtual mobile terminal 40 may interwork with the real mobile terminal 50 of the user.

In the WebRTC-based call initiating step (S4000), the virtual mobile terminal implementing device 20 may sense the touch for the call object of the virtual mobile terminal 40 to initiate the call. In this case, the virtual mobile terminal implementing device 20 may generate the communication identifier for initiating the WebRTC call, and transmit the communication identifier to the call partner device 70 of the call partner to initiate the WebRTC-based call.

In the virtual mobile terminal implementing method and the virtual mobile terminal implementing system using the same according to the present disclosure described above, steps constituting the respective exemplary embodiments are not necessary, and the respective exemplary embodiments may thus selectively include the steps described above. In addition, the respective steps constituting the respective exemplary embodiments are not necessarily performed in the described sequence, and the steps described later may be formed before the steps described earlier. In addition, any one step may be repeatedly performed during a period in which the respective steps are operated.

1. A control method of a virtual mobile terminal implementing device implementing a virtual mobile terminal used in mixed reality, comprising:
implementing a mixed reality scene by mixing an artificially implemented virtual object with real objects sensed in the virtual mobile terminal implementing device;
detecting a target object including an identification tag among the real objects sensed after the mixed reality scene is implemented; and
implementing an image of the virtual mobile terminal in at least a partial region of the target object.

2.The control method of claim 1, further comprising establishing a WebRTC communication connection with a terminal of another user that is not a user of the virtual mobile terminal through an interface provided in the virtual mobile terminal.

3. The control method of claim 2, wherein in the establishing of the WebRTC communication connection, the WebRTC communication connection with the terminal of another user is established using a browser installed in the virtual mobile terminal implementing device.

4. The control method of claim 3, wherein the implementing of the image of the virtual mobile terminal includes:
implementing a virtual object for using the virtual mobile terminal in the target object;
sensing a touch of the virtual object; and
performing an operation of the virtual mobile terminal corresponding to the virtual object of which the touch is sensed.

5. The control method of claim 2, wherein the establishing of the WebRTC communication connection includes:
sensing a touch of the WebRTC communication connection object; and
establishing a call to the terminal of another user based on the WebRTC communication connection in response to the touch of the WebRTC communication connection object.

6. The control method of claim 4, wherein in the sensing of the touch of the virtual object, in the case in which the virtual object of the virtual mobile terminal is touched, the touch of the virtual object is sensed on the basis of a sound generated due to a material of a region of the target object in which the virtual object is implemented.

7. The control method of claim 6, wherein in the sensing of the touch of the virtual object, the touch of the virtual object is sensed by sensing a change in an image of a region in which the virtual object of the virtual mobile terminal is formed.

8. The control method of claim 7, wherein in the sensing of the touch of the virtual object, the touch of the virtual object is sensed by sensing a velocity of an object moving toward the virtual object.

9. The control method of claim 5, wherein the implementing of the image of the virtual mobile terminal includes sensing a form of a region of the target object in which the virtual mobile terminal is implemented.

10. The control method of claim 9, wherein in the detecting of the target object, the form of the region of the target object is sensed on the basis of a form of the identification tag of the target object in the mixed reality scene.

11. The control method of claim 10, wherein a region of the target object changed depending on rotation or movement of the target object is detected, and
a virtual mobile terminal image is implemented in the detected region of the target object.

12. The control method of claim 9, wherein in the establishing of the WebRTC communication connection, a communication identifier is generated as a predetermined link.

13. The control method of claim 12, wherein in the establishing of the WebRTC communication connection, a predetermined parameter for controlling the call is added to the communication identifier.

14. The control method of claim 13, wherein a kind of call is determined depending on the parameter added to the communication identifier.

15. The control method of claim 14, wherein in the case in which the kind of call is a video call, a call image by the video call is implemented in the virtual mobile terminal in the implementing of the image of the virtual mobile terminal.

16. The control method of claim 15, further comprising, in the case in which the kind of call is the video call:
transmitting media data to a media server; and
obtaining the media data from the media server to implement the call image.

17. The control method of claim 16, further comprising obtaining data of a real mobile terminal,
wherein the image of the virtual mobile terminal is implemented on the basis of the data of the real mobile terminal.

18. The control method of claim 1, wherein the virtual mobile terminal implementing device replaces the mixed reality by virtual reality or augmented reality.

19. A computer readable recording medium in which a program for performing a control method of a virtual mobile terminal implementing device implementing a virtual mobile terminal used in mixed reality is recorded, wherein the control method includes:
implementing a mixed reality scene by mixing an artificially implemented virtual object with real objects sensed in the virtual mobile terminal implementing device;
detecting a target object including an identification tag among the real objects sensed after the mixed reality scene is implemented; and
implementing an image of the virtual mobile terminal in at least a partial region of the target object.

20. A virtual mobile terminal implementing apparatus comprising:
a sensing portion sensing a real object of a real world;
an output portion outputting a mixed reality scene including the sensed real object and an artificially implemented virtual object; and
a control portion detecting a target object in the mixed reality scene on the basis of an identification tag, implementing an image of a virtual mobile terminal in a region in which the target object is detected, and establishing a WebRTC communication connection by transmitting a communication identifier including a unique identification (ID) for establishing the WebRTC communication connection to a call partner device in the case in which a call request through the virtual mobile terminal in the mixed reality scene is received.
